(19) United States
(12) Patent Application Publication
(10) Pub. No.: US 2014/0235783 A1
(43) Pub. Date: Aug. 21, 2014

(54) COMPOSITION AND COATED ARTICLE

(71) Applicant: DAIKIN INDUSTRIES, LTD., Osaka-shi, Osaka (JP)

(72) Inventors: Mayumi Iida, Settsu-shi (JP); Katsuhiko Imoto, Settsu-shi (JP); Yoshinari Fukuhara, Settsu-shi (JP); Shumi Yoshida, Settsu-shi (JP)

(21) Appl. No.: 14/347,167

(22) PCT Filed: Oct. 1, 2012
(86) PCT No.: PCT/JP2012/075430

§ 371 Date: Mar. 25, 2014

(30) Foreign Application Priority Data
Sep. 30, 2011 (JP) 2011-218500

(51) Int. Cl. C09D 127/18

(52) U.S. Cl. CPC C09D 127/18
USPC 524/520; 525/199

(57) ABSTRACT

The present invention aims to provide a composition that forms a film excellent in freeze-thaw resistance, as well as in transparency, weather resistance, adhesion to a base material, and blocking resistance. The present invention relates to a composition comprising polymer particles (A) and a crosslinking agent (B), the polymer particles (A) obtainable by seed polymerization of at least one monomer selected from the group consisting of acrylic acid esters and methacrylic acid esters, an unsaturated carboxylic acid, and a hydrolyzable silyl group-containing monomer in the presence of fluoropolymer particles as seed particles, and the crosslinking agent (B) having at least one group selected from the group consisting of aziridine, carbodiimide, and oxazoline groups.

### TECHNICAL FIELD

The present invention relates to a composition that is suitably used as a coating composition especially for a siding material.

### BACKGROUND ART

Fluorine-containing seed polymers are used in various industrial fields, such as the automobile industry, semiconductor industry, chemical industry, and paint industry, as raw materials for various products or as film-forming components of coating compositions, owing to the weather resistance, chemical resistance, solvent resistance, heat resistance, and antifouling property of contained fluoropolymers and the processability, transparency, adhesion, and film-forming property of the contained acrylic polymers.

For example, Patent Literature 1 discloses an aqueous dispersion of vinylidene fluoride seed polymers obtainable by emulsion polymerization of an ethylenically unsaturated monomer in the presence of a vinylidene fluoride copolymer of a vinylidene fluoride monomer and a reactive emulsifier having a specific structure, wherein the aqueous dispersion has a solid content concentration of 30 to 60% by weight and has an average particle size of the seed polymers of at most 200 nm.

Patent Literature 2 discloses emulsion polymerization of an ethylenically unsaturated monomer in the presence of fluoropolymer particles in an aqueous medium, wherein the fluoropolymer is used as a seed polymer.

Patent Literature 3 discloses a cross-linkable fluororesin aqueous dispersion composition including: a fluororesin aqueous dispersion that contains at least 10% by weight of fluorine and has a carboxyl group and/or a sulfonic acid group; and a crosslinking agent having an aziridine, carbodiimide, or oxazoline group.

### CITATION LIST

### Patent Literature

Patent Literature 1: JP-A H08-67795
Patent Literature 2: JP-B H04-55441
Patent Literature 3: JP-A 2001-72819

### SUMMARY OF INVENTION

### Technical Problem

In the case of emulsion polymerization of an ethylenically unsaturated monomer in the presence of a fluoropolymer as seed particles, however, there is a problem that, if the amount of an acrylic monomer used in seed polymerization is large, a formed film has white turbidity. In addition, a coating composition including a polymer obtained by a conventional seed polymerization method is still to be improved in the adhesion to a base material, blocking resistance, and freeze-thaw resistance.

The present invention aims to provide a composition that forms a film excellent in freeze-thaw resistance, as well as in transparency, weather resistance, adhesion to a base material, and blocking resistance.

### Solution to Problem

As a result of intensive studies about a composition that can form a film that is excellent in transparency, weather resistance, adhesion to a base material, blocking resistance, and freeze-thaw resistance, the present inventors found out that a film formed from a composition containing specific polymer particles and a specific crosslinking agent is excellent in transparency, adhesion to a base material, and blocking resistance. In addition, the present inventors found out that such a film is also excellent in freeze-thaw resistance.

The present invention relates to a composition including polymer particles (A) and a crosslinking agent (B), the polymer particles (A) obtainable by seed polymerization of at least one monomer selected from the group consisting of acrylic acid esters and methacrylic acid esters, an unsaturated carboxylic acid, and a hydrolyzable silyl group-containing monomer in the presence of fluoropolymer particles as seed particles, and the crosslinking agent (B) having at least one group selected from the group consisting of aziridine, carbodiimide, and oxazoline groups.

Preferably, the polymer particles (A) contain a polymerization unit derived from the acrylic acid esters and methacrylic acid esters in an amount of 40 to 400% by mass relative to the amount of the seed particles, and a polymerization unit derived from the hydrolyzable silyl group-containing monomer in an amount of 0.1 to 2% by mass relative to the amount of the polymerization unit derived from the acrylic acid esters and methacrylic acid esters.

Preferably, the seed particles are fluoropolymer particles derived from at least one fluoroolefin selected from the group consisting of vinyl fluoride, vinylidene fluoride, tetrafluoroethylene, hexafluoropropylene, and chlorotrifluoroethylene.

Preferably, the hydrolyzable silyl group-containing monomer is at least one selected from the group consisting of γ-methacryloxypropyl trimethoxysilane, γ-methacryloxypropylmethyl dimethoxysilane, γ-methacryloxypropyl triethoxysilane, and γ-methacryloxypropylmethyl diethoxysilane.

The present invention also relates to a coated article including a base material, and a film obtainable by application of the composition.

Preferably, the coated article of the present invention is a siding material.

### Advantageous Effects of Invention

Since having features described above, the composition of the present invention can form a film that is excellent in transparency, weather resistance, adhesion to a base material, blocking resistance, and freeze-thaw resistance.

### DESCRIPTION OF EMBODIMENTS

The composition of the present invention contains polymer particles (A) obtainable by seed polymerization of at least one monomer selected from the group consisting of acrylic acid esters and methacrylic acid esters, an unsaturated carboxylic acid, and a hydrolizable silyl group-containing monomer in the presence of fluoropolymer particles as seed particles. Seed polymerization of an ester of acrylic acid or methacrylic acid and a hydrolizable silyl group-containing monomer enables formation of a film excellent in transparency.

The composition of the present invention preferably contains water because it is to be applied to a base material to produce a coated article. For example, the composition may be an aqueous dispersion containing the polymer particles (A) dispersed in an aqueous solvent or an aqueous solution containing the polymer particles (A) dissolved in water. The aqueous solvent is commonly water, and may contain organic solvents such as alcohols, glycol ethers or esters, provided that it does not impair the effect of the present invention.

The seed particles are fluoropolymer particles. Any fluoropolymers may constitute the seed particles, provided that they contain at least one fluoroolefin unit.

Examples of the fluoroolefin include: perfluoroolefins such as tetrafluoroethylene (TFE), hexafluoropropylene (HFP), perfluoro(alkyl vinyl ether) (PAVE), and

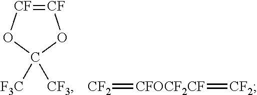

and non-perfluoroolefins such as chlorotrifluoroethylene (CTFE), vinyl fluoride (VF), vinylidene fluoride (VdF), trifluoroethylene, trifluoropropylene, pentafluoropropylene, tetrafluoropropylene, and hexafluoroisobutene. Examples of the PAVE include perfluoro(methyl vinyl ether) (PMVE), perfluoro(ethyl vinyl ether) (PEVE), and perfluoro(propyl vinyl ether) (PPVE).

A functional group-containing fluoroolefin may also be used. Examples of the functional group-containing fluoroolefin include compounds represented by the formula (1):

CX¹₂═CX²-(Rf)ₘ-Y¹ (1)

(wherein Y¹ represents —OH, —COOH, —SO₂F, —SO₃M² (M² represents a hydrogen atom, a NH₄ group, or an alkali metal), a carboxylate salt, a carboxy-ester group, an epoxy group, or a cyano group; X¹ and X² are the same as or different from each other, and each represent a hydrogen or fluorine atom; Rf represents a C1-C40 divalent fluoroalkylene group or a divalent fluoroalkylene group having a C2-C40 ether bond; and m represents 0 or 1).

Specific examples of the functional group-containing fluoroolefin include compounds represented by the following formulae:

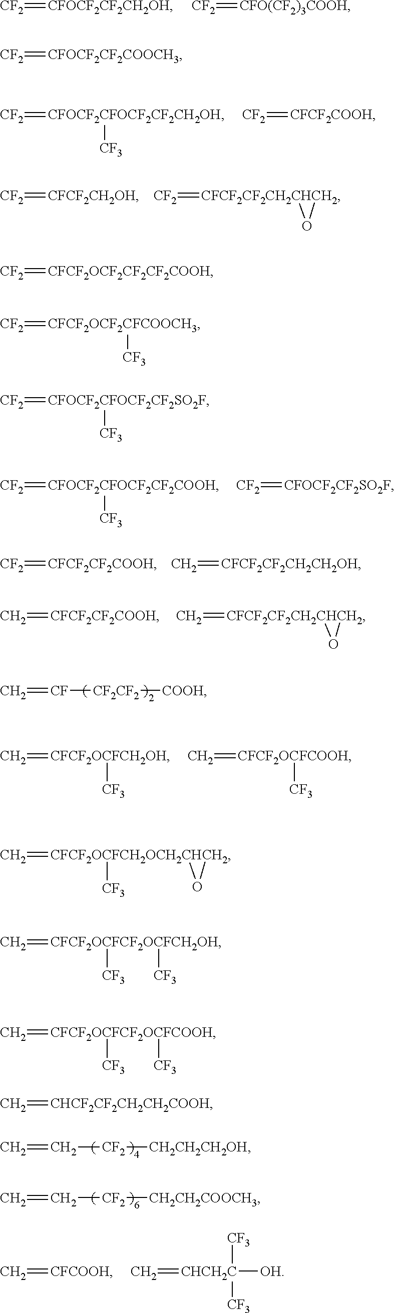

Examples of usable fluoroolefins include iodine-containing monomers such as iodinated perfluorovinyl ethers (e.g., perfluoro(6,6-dihydro-6-iodo-3-oxa-1-hexene) disclosed in JP-B H05-63482 and perfluoro(5-iodo-3-oxa-1-pentene) disclosed in JP-A S62-12734).

The seed particles may be fluoropolymer particles obtained by copolymerization of a fluoroolefin and a fluorine-free monomer that is copolymerizable with the fluoroolefin. Examples of the fluorine-free monomer that is copolymerizable with a fluoroolefin include: olefins such as ethylene, propylene, and isobutylene; and vinyl ether monomers, allyl ether monomers, vinyl ester monomers, acrylic monomers, and methacrylic monomers.

The seed particles are preferably fluorocopolymer particles having a polymerization unit derived from VdF because the weather resistance is favorable and a formed film has excellent transparency. In terms of compatibility with acrylic polymers, the seed particles contain a polymerization unit derived from VdF in an amount of preferably at least 50 mol % and more preferably at least 70 mol % relative to the amount of the total polymerization unit of the seed particles. The amount of the polymerization unit is preferably at most 95 mol %.

Specifically, the fluorocopolymers containing a polymerization unit derived from VdF are preferably particles of at least one fluorocopolymer selected from the group consisting of VdF/TFE/CTFE copolymers, VdF/TFE copolymers, VdF/TFE/HFP copolymers, VdF/CTFE copolymers, VdF/HFP copolymers and PVdF. More preferably, the fluorocopolymers include: VdF/TFE/CTFE=40-99/1-50/0-30 (mol %), VdF/TFE=50-99/1-50 (mol %), VdF/TFE/HFP=45-99/0-35/5-50 (mol %), VdF/CTFE=40-99/1-30 (mol %), or VdF/HFP=50-99/1-50 (mol %).

The production method of the seed particles is not limited, and a conventionally known emulsion polymerization method may be employed.

Next, a description is given on a monomer for seed polymerization. In seed polymerization, at least one monomer selected from the group consisting of acrylic acid esters and methacrylic acid esters, an unsaturated carboxylic acid, and a hydrolyzable silyl group-containing monomer are used. In addition, a monomer having a radical-polymerizable ethylenically unsaturated bond may be used together.

The acrylic acid esters or methacrylic acid esters are preferably acrylic acid alkyl esters or methacrylic acid alkyl esters having C1-C10 alkyl groups. Examples of the acrylic acid alkyl esters and methacrylic acid alkyl esters include (meth)acrylic acid alkyl esters such as methyl acrylate, ethyl acrylate, n-propyl acrylate, isopropyl acrylate, n-butyl acrylate, methyl methacrylate, n-propyl methacrylate, ethyl methacrylate, n-butyl methacrylate, isopropyl methacrylate, 2-ethylhexyl acrylate, 2-ethylhexyl methacrylate, cyclohexyl acrylate, and cyclohexyl methacrylate. Each of these acrylic acid esters or methacrylic acid esters may be used alone, or two or more of these may be used in combination. Preferably used are n-butyl acrylate and methyl methacrylate.

Particularly preferred is at least one (meth)acrylic acid alkyl ester selected from the group consisting of methyl methacrylate, n-butyl acrylate, 2-ethylhexyl methacrylate, and cyclohexyl methacrylate in terms of excellent transparency and film-forming property. Here, the acrylic acid ester or methacrylic acid ester does not contain a hydrolyzable silyl group.

2-Ethylhexyl methacrylate improves the freeze-thaw resistance of a resulting film.

In terms of excellent transparency, blocking resistance, and resistance to hot water, the acrylic acid esters or methacrylic acid esters are more preferably a combination of n-butyl acrylate and methyl methacrylate or a combination of n-butyl acrylate, methyl methacrylate, and 2-ethylhexyl methacrylate. From the standpoint of obtaining a film with excellent freeze-thaw resistance, a combination of n-butyl acrylate, methyl methacrylate, and 2-ethylhexyl methacrylate is particularly preferable.

The polymer particles (A) contain a polymerization unit derived from acrylic acid esters and methacrylic acid esters in an amount of preferably 40 to 400% by mass relative to the amount of the seed particles. If the amount is less than 40% by mass, a film obtainable by application of the composition of the present invention to a base material may have poor flexibility and blocking resistance. If the amount is more than 400% by mass, the weather resistance may be lowered. In terms of favorable weather resistance, the amount is preferably at most 400% by mass, and more preferably at most 300% by mass. In terms of favorable flexibility and blocking resistance, the amount is preferably at least 40% by mass, and more preferably at least 45% by mass.

Specific examples of the unsaturated carboxylic acids include acrylic acid, methacrylic acid, vinyl acetate, crotonic acid, cinnamic acid, 3-allyloxypropionic acid, 3-(2-allyloxyethoxycarbonyl)propionic acid, itaconic acid, itaconic acid monoesters, maleic acid, maleic acid monoesters, maleic acid anhydrides, fumaric acid, fumaric acid monoesters, vinyl phthalate, vinyl pyromellitate, and undecylenic acid. Particularly preferred is at least one selected from the group consisting of acrylic acid, methacrylic acid, vinyl acetate, crotonic acid, itaconic acid, maleic acid, maleic acid monoesters, fumaric acid, fumaric acid monoesters, 3-allyloxypropionic acid, and undecylenic acid, because they are less likely to form homopolymers due to their low homopolymerizability and because introduction of carboxyl groups can be easily controlled.

The polymer particles (A) preferably have an acid value of preferably 2.5 to 20 mgKOH/g, and more preferably 5 to 15 mgKOH/g. The acid value can be adjusted by adjusting the unsaturated carboxylic acid content in the polymer particles (A). The glass transition temperature is preferably at least 20° C., and more preferably at least 35° C.

Examples of the hydrolyzable silyl group-containing monomer include

### CH₂═CHSi(OCH₃)₃,

### CH₂═CHSi(CH₃)(OCH₃)₂,

### CH₂═C(CH₃)Si(OCH₃)₃,

### CH₂═C(CH₃)Si(CH₃)(OCH₃)₂,

### CH₂═CHSi(OC₂H₅)₃,

### CH₂═CHSi(OC₃H₇)₃,

### CH₂═CHSi(OC₄H₉)₃,

### CH₂═CHSi(OC₆H₁₃)₃,

### CH₂═CHSi(OC₈H₁₇)

### CH₂═CHSi(OC₁₀H₂₁)₃,

### CH₂═CHSi(OC₁₂H₂₅)₃,

### CH₂═CHCOO(CH₂)₃Si(OCH₃)₃,

### CH₂═CHCOO(CH₂)₃Si(CH₃)(OCH₃)₂,

### CH₂═CHCOO(CH₂)₃Si(OC₂H₅)₃,

### CH₂═CHCOO(CH₂)₃Si(CH₃)(OC₂H₅)₂,

### CH₂═C(CH₃)COO(CH₂)₃Si(OCH₃)₃,

### CH₂═C(CH₃)COO(CH₂)₃Si(CH₃)(OCH₃)₂,

### CH₂═C(CH₃)COO(CH₂)₃Si(OC₂H₅)₃,

### CH₂═C(CH₃)COO(CH₂)₃Si(CH₃)(OC₂H₅)₂,

### CH₂═C(CH₃)COO(CH₂)₂O(CH₂)₃Si(OCH₃)₃,

### CH₂═C(CH₃)COO(CH₂)₂(CH₂)₃Si(CH₃)(OCH₃)₂,

### CH₂═C(CH₃)COO(CH₂)₁₁Si(OCH₃)₃,

### CH₂═C(CH₃)COO(CH₂)₁₁Si(CH₃)(OCH₃)₂,

### CH₂═CHCH₂OCO(o-C₆H₄)COO(CH₂)₃Si(OCH₃)₃,

### CH₂═CHCH₂OCO(o-C₆H₄)COO(CH₂)₃Si(CH₃)(OCH₃)₂,

### CH₂═CH(CH₂)₄Si(OCH₃)₃,

### CH₂═CH(CH₂)₈Si(OCH₃)₃,

### CH₂═CHO(CH₂)₃Si(OCH₃)₃,

### CH₂═CHCH₂O(CH₂)₃Si(OCH₃)₃, and

### CH₂═CHCH₂OCO(CH₂)₁₀Si(OCH₃)₃.

Each of these hydrolyzable silyl group-containing monomers may be used alone, or two or more of these may be used in combination.

In terms of favorable water resistance, resistance to hot water, and storage stability, particularly preferred is at least one selected from the group consisting of γ-methacryloxypropyl trimethoxysilane, γ-methacryloxypropyl methyldimethoxysilane, γ-methacryloxypropyl triethoxysilane, and γ-methacryloxypropyl methyldiethoxysilane. More preferred is γ-methacryloxypropyl triethoxysilane.

In the polymer particles (A), the amount of the polymerization unit derived from the hydrolyzable silyl group-containing monomer is preferably 0.1 to 2% by mass relative to the amount of the polymerization unit derived from acrylic acid esters and methacrylic acid esters. If the amount is less than 0.1% by mass, the resistance to hot water, water resistance, adhesion, and compatibility may be insufficient. If the amount is more than 2% by mass, the film-forming property and storage stability may be unstable. In terms of favorable film-forming property and storage stability, the upper limit is more preferably 1.5% by mass. In terms of favorable resistance to hot water and adhesion, the lower limit is more preferably 0.2% by mass.

Preferable examples of other copolymerizable monomers having radical-polymerizable ethylenically unsaturated bonds include hydroxyl group-containing alkyl vinyl ethers, carboxylic acid vinyl esters, and α-olefins.

Specific examples of the hydroxyl group-containing alkyl vinyl ethers include 2-hydroxyethyl vinyl ether, 3-hydroxypropyl vinyl ether, 2-hydroxypropyl vinyl ether, 2-hydroxy-2-methyl propyl vinyl ether, 4-hydroxybutyl vinyl ether, 4-hydroxy-2-methyl butyl vinyl ether, 5-hydroxypentyl vinyl ether, 6-hydroxyhexyl vinyl ether, 2-hydroxyethyl allyl ether, 4-hydroxybutyl allyl ether, and glycerol monoallyl ether. In terms of excellent polymerization reactivity, at least one selected from the group consisting of 4-hydroxybutyl vinyl ether and 2-hydroxyethyl vinyl ether is preferable.

Specific examples of the carboxylic acid vinyl esters include vinyl acetate, vinyl propionate, vinyl butyrate, vinyl isobutryrate, vinyl pivalate, vinyl caproate, vinyl versatate, vinyl laurate, vinyl stearate, vinyl cyclohexyl carboxylate, vinyl benzoate, and vinyl para-t-butyl benzoate. Carboxylic acid vinyl esters used in the composition of the present invention provide a resulting film with improved gloss and a higher glass transition temperature.

Examples of the α-olefins include ethylene, propylene, n-butene, isobutene, and styrene. α-Olefins used provide a film formed from the composition of the present invention with better properties such as improved flexibility.

In the polymer particles (A), the amount of the polymerization unit derived from other copolymerizable monomers having radical-polymerizable ethylenically unsaturated bonds is preferably 0 to 4% by mass relative to the amount of the polymerization unit derived from acrylic acid esters and methacrylic acid esters. The amount is more preferably 0.1 to 3% by mass, and still more preferably 0.1 to 2.5% by mass.

The polymer particles (A) may be prepared by adding monomers for seed polymerization and a polymerization initiator in the presence of an emulsifier to an aqueous dispersion containing fluoropolymers as seed particles and emulsion-polymerizing the mixture.

In polymerization of the monomers for seed polymerization, the polymerization temperature may be 10° C. to 90° C. and the polymerization time may be 0.5 to 6 hours.

As the emulsifier, a reactive emulsifier or non-reactive emulsifier may be used alone, or both of them may be used in combination. As the non-reactive emulsifier, a conventionally known anionic emulsifier or nonionic emulsifier may be used alone, or both of them may be used in combination. In some cases, an ampholytic emulsifier may be used. Examples of the emulsifier include Newcol 707SF (Nippon Nyukazai Co., Ltd.) and EMULGEN 120 (Kao Corporation).

The polymerization initiator is not limited as long as it can be used in a free radical reaction in water. In some cases, the polymerization initiator can be used in combination with a reducing agent. Examples of usable water-soluble polymerization initiators include persulfates and hydrogen peroxides, and persulfates are preferably used. Examples of the persulfates include ammonium persulfate, sodium persulfate, and potassium persulfate. More preferred is ammonium persulfate. Examples of usable reducing agents include sodium pyrobisulfite, sodium hydrogen bisulfite, sodium L-ascorbate, and Rongalite. Examples of oil-soluble polymerization initiators include diisopropyl peroxydicatbonate (IPP), benzoyl peroxide, dibutyl peroxide, and azobisisobutylonitrile (AIBN). The amount used of the polymerization initiator is preferably 0.0001 to 2.0 parts by mass based on 100 parts by mass of the monomers for seed polymerization.

The resulting polymer particles (A) have a fluorine content of preferably 25 to 80% by mass, and more preferably 30 to 50% by mass.

The resulting polymer particles (A) have a particle size of preferably 50 to 500 nm, and more preferably 150 to 250 nm.

The aqueous dispersion containing the polymer particles (A) may be optionally mixed with water, film-forming aids, defoamers, thickeners, pH adjusters, and other required additives by a known method.

Examples of the film-forming aids include diethylene glycol monobutyl ether, diethylene glycol monobutyl ether acetate, DEDG (diethylene glycol diethyl ether), diethyl adipate, dibutyl adipate, Texanol, and Rhodiasolv DEE. Preferred among these is DEDG.

Examples of the defoamers include BYK028 (BYK Japan KK), FS ANTIFOAM 013B (DOW CORNING TORAY Co., Ltd.), and SN8034 (SAN NOPCO LIMITED).

Examples of the pH adjusters include sodium hydroxide aqueous solutions, triethylamine, and ammonium water. Preferred are triethylamine and ammonium water.

The aqueous dispersion containing the polymer particles (A) has a minimum film-forming temperature of preferably −5° C. to 60° C., and more preferably 15° C. to 40° C.

The composition of the present invention contains a crosslinking agent (B) having at least one group selected from the group consisting of aziridine, carbodiimide, and oxazoline groups.

Examples of the crosslinking agents having aziridine groups include XAMA2 and XAMA7 supplied by BF-Goodrich.

Examples of the crosslinking agents having carbodiimide groups include UCARLNK Crosslinker XL-29SE supplied by Union Carbide Corporation, CARBODILITE E-02, E-04, SV-02, V-02V-02-L2, V-04, V-10, and the like supplied by Nisshinbo Chemical Inc. Preferred is CARBODILITE E-02.

Examples of the crosslinking agents having oxazoline groups include EPOCROS K-1010E, EPOCROS K-1020E, EPOCROS K-1030E, EPOCROS K-2010E, EPOCROS K-2020E, EPOCROS K-2030E, EPOCROS WS-500, and the like supplied by NIPPON SHOKUBAI CO., LTD. Preferred is EPOCROS WS-500.

In terms of the transparency, adhesion thereof to a base material, and handling safety of a film formed from the composition of the present invention, the crosslinking agent (B) having at least one group selected from the group consisting of aziridine, carbodiimide, and oxazoline groups is preferably a crosslinking agent having at least one group selected from the group consisting of oxazoline groups and carbodiimide groups.

Exemplary methods for adding the crosslinking agent (B) include a method in which the crosslinking agent (B) dissolved or dispersed in water is added to the aqueous dispersion of the polymer particles (A), a method in which the crosslinking agent (B) dissolved in a small amount of a water-soluble organic solvent is added to the aqueous dispersion of the polymer particles (A), and a method in which the crosslinking agent (B) is directly added to the aqueous dispersion of the polymer particles (A).

The crosslinking agent (B) reacts with carboxyl groups introduced in the polymer particles (A) to forma cross-linked structure. As a result, water resistance such as resistance to hot water, initial water resistance, and contamination resistance, is enhanced and the hardness of the film is improved.

The composition of the present invention contains the crosslinking agent (B) preferably in an amount that makes the total amount of the aziridine, carbodiimide, and oxazoline groups be 0.1 to 4 equivalents relative to the amount of the carboxyl groups in the polymer particles (A). If the amount is less than 0.1 equivalents, only insufficient improvement may be found in the resistance to hot water of a film owing to crosslinking, and also, only insufficient improvement may be found in the blocking resistance, contamination inhibition, and contamination removability owing to the enhanced hardness. If the amount is more than 4 equivalents, water resistance of the film, and the storage stability and weather resistance of the composition tend to be lowered. The amount of the carboxyl groups is calculated based on the amount added in the seed polymerization.

The composition of the present invention may optionally contain film-forming aids, antifreezing agents, fillers, defoamers, leveling agents, rheology control agents, preservatives, ultraviolet absorbers, antioxidants, delusterants, lubricants, seaweed-proofing agents, and crosslinking agents other than the crosslinking agent (B).

The composition of the present invention can be used for various applications. Examples of typical applications include various coating compositions and molding materials for forming films and sheets.

Conventionally known additives and compounding ratios may be employed for preparing the composition of the present invention, provided that the polymer particles (A) are used as a film-forming material. For example, the composition of the present invention preferably contains 10 to 60% by mass of the polymer particles (A).

In the case where the composition of the present invention is a coating composition containing pigments, the composition may be prepared as follows, for example. First, an aqueous dispersion containing the polymer particles (A) is mixed with a predetermined amount of a pigment dispersion and a predetermined amount of a film-forming aid. The pigment dispersion is prepared by dispersing pigments (e.g., titanium oxide), defoamers, pigment dispersants, and pH adjusters in water using a pigment disperser such as a sand mill. Then, a predetermined amount of a thickener is added thereto, and other required additives are appropriately added to the mixture. In the case of preparing an aqueous coating composition not containing pigments, the aqueous dispersion containing the polymer particles (A) may be optionally mixed with water, film-forming aids, defoamers, thickeners, pH adjusters, and other required additives by a known method.

As additives for coating compositions, optionally used are film-forming aids, antifreezing agents, pigments, fillers, pigment dispersants, defoamers, leveling agents, rheology control agents, preservatives, ultraviolet absorbers, antioxidants, delusterants, lubricants, and crosslinking agents other than the crosslinking agent (B).

The coated article of the present invention includes a base material and a film formed from the composition applied to the base film. The coated article of the present invention has a film formed from the applied composition, and therefore has excellent resistance to hot water and suppresses white turbidity of the film during formation thereof. Since the resistance to hot water is enhanced, adhesion between the film and the base material is excellent even after exposure to hot water.

The base material may be appropriately selected in accordance with applications described later. Examples thereof include ceramic base materials and slate base materials.

The composition of the present invention may be applied by a conventionally known method under conventionally known conditions. For example, the composition is applied to a base material by a method, such as spray coating, roll coating, flow coating, and application using a roller or brush, thereby forming a film. Then, the film is dried at 5° C. to 200° C. Such a method allows formation of a film that has excellent weather resistance, gloss, and transparency, less foaming, and sufficient resistance to hot water, and is not likely to deteriorate even after repetitive freezing and melting.

The coated article produced by application of the composition of the present invention is usable for various applications. Exemplary applications include: coating of inner and outer packages of electric appliances (e.g., microwave ovens, toasters, refrigerators, washing machines, hair dryers, TVs, VCRs, amplifiers, radios, electric pots, rice cookers, radio cassette players, cassette decks, CD players, video cameras), indoor units, outdoor units, air outlets, and air ducts of air conditioners, inner and outer packages of air conditioners (e.g., air cleaners, heaters), lighting fixtures such as fluorescent lamps, chandeliers, and reflectors, furniture, machine components, decorations, combs, eyeglass frames, natural fibers, synthetic fibers (including threads and fabrics obtainable therefrom), office furniture (telephones, FAX machines, copying machines (including rolls), cameras, overhead projectors, projection cameras, clocks, slide projectors, desks, bookshelves, lockers, file cabinets, chairs, book ends, electric white boards), automobiles (wheels, door mirrors, moldings, door knobs, license plates, steering wheels, instrument panels), and cooking utensils (range hoods, kitchen sinks, kitchen tables, kitchen knives, cutting boards, water outlets, gas stoves, exhaust fans); interior coating of partitions, bath units, shutters, window blinds, curtain rails, accordion curtains, walls, ceilings, and floors; exterior coating of dwelling houses and buildings (outer walls, balustrades, gates, shutters) and exterior finishing materials for buildings (ceramic sizing materials, foamed concrete panels, concrete panels, aluminum curtain walls, steel plates, galvanized steel plates, stainless steel plates, PVC sheets, PET films, polycarbonates, acrylic films), siding materials, windowpanes, and the like.

The coated article obtainable by applying the composition of the present invention to a base material is preferably a siding material. Examples of the siding material include ceramic siding materials, metal siding materials, and plastic siding materials.

Ceramic siding materials often have an acrylic, acrylic silicon, or acrylic urethane film on its surface for achieving water resistance, weather resistance, and better appearance. The film formed from the composition of the present invention strongly adheres even to an acrylic film, and is excellent in resistance to hot water and transparency. That means, the coated article of the present invention is especially suitable as a ceramic siding material. The ceramic siding material includes, for example, a ceramic base material and a film obtainable by applying the composition to the ceramic base material. The ceramic base material may have a surface formed of an acrylic resin.

A conventionally known ceramic base material may be used. Base materials having a known composition may be used, such as those obtained through the process of dehydration press molding, drying, and curing performed on a wet sheet formed from an aqueous slurry mainly containing cement, and those obtained by molding, such as extrusion-molding or cast-molding, an aqueous admixture containing cement and the like and curing a resulting molded product. The ceramic base material may be a molded product having an acrylic resin layer on the surface.

### EXAMPLES

The present invention is specifically described with reference to, but not limited to, examples.

Devices and conditions used in characteristic evaluation are listed below.

### (1) Fluorine Content

The fluorine content was measured with an automatic quick furnace (AQF-100 produced by Mitsubishi Chemical Corporation) including an ion chromatography system (ICS-1500 produced by DIONEX).

### (2) Minimum Film-Forming Temperature

The minimum film-forming temperature (MFT) was measured with a thermal gradient-type MFT measuring device (Nihon Rika Kiki Co., Ltd.).

### (3) Average Particle Size

An emulsion to be subjected to measurement was diluted with water to a measurable concentration, thereby giving a test sample. The test sample was subjected to measurement using a MICRO TRACK UPA (HONEYWELL) by dynamic light scattering at ambient temperatures. The number average size of the obtained data was regarded as a particle size.

### (4) Resistance to Hot Water

The resulting composition was sprayed to a slate plate (preliminary coated with a primer that is an acrylic coating composition (Mowinyl 7151 (product name) produced by The Nippon Synthetic Chemical Industry Co., Ltd., in an amount of 120 g/m², and then dried at ambient temperatures for a day), in an amount of 90 g/m² and then dried at 35° C. for three days, thereby producing a test coated plate.

After immersion in hot water at 60° C. for 14 days, the plate was taken out of the hot water and subjected to visual observation for finding any defects in the film.

The evaluation criteria were as follows.

++: Film with no white turbidity of the film.
+: Film partly with slight white turbidity.
−: Film with white turbidity throughout the surface.

### (5) Freeze-Thaw Resistance

The resulting composition was sprayed to a slate plate (preliminary coated with a primer that is an acrylic coating composition (Mowinyl 7151 (product name) produced by The Nippon Synthetic Chemical Industry Co., Ltd., in an amount of 120 g/m², and then dried at ambient temperatures for a day), in an amount of 90 g/m² and then dried at 35° C. for three days, thereby producing a test coated plate.

The plate was left in the air at −20° C. for two hours and then in water at ambient temperatures for 1.5 hours. This cycle was repeated for 200 times. After the test, defects in the film were visually checked. The evaluation criteria were as follows.

++: No crack was found on the film.
+: Slight cracks were found on a part of the film.
−: Cracks were found throughout the film.

### (6) Blocking Resistance

The composition was applied to an aluminum plate with a 6-mil applicator. The plate was dried by heating at 100° C. for three minutes. Directly after the drying, expanded polyurethane was placed on the plate. The plate was left to stand under a load of 2.5 kg/cm² at 40° C. After 16 hours, the plate was visually checked based on the following evaluation criteria.

++: No polyurethane mark was found on the film.
+: Slight polyurethane marks were found on the film.
−: Polyurethane marks were clearly found on the film.

### (7) Transparency

The resulting composition was sprayed to a slate plate (preliminary coated with a primer that is an acrylic coating composition (Mowinyl 7151 (product name) produced by The Nippon Synthetic Chemical Industry Co., Ltd.), in an amount of 120 g/m², and then dried at ambient temperatures for a day), in an amount of 90 g/m² and ten dried at 35° C. for three days, thereby producing a test coated plate.

The transparency of the formed film was visually observed based on the following evaluation criteria.

++: No turbidity was found in the film.
+: Slight turbidity was found in the film.
−: White turbidity was found throughout the film.

### Synthesis Example 1

A 0.5-L four-necked glass separable flask equipped with a stirrer, a reflux tube, a thermometer, and an addition funnel was charged with 199.68 parts by mass of an aqueous dispersion (solid content concentration of 45.5% by mass) of VdF/TFE/CTFE copolymers (VdF/TFE/CTFE=72.1/14.9/13 (mol %)) as an aqueous dispersion containing fluoropolymer seed particles, 12.75 parts by mass of Newcol 707SF (Nippon Nyukazai Co., Ltd.), and 35 parts by mass of ion-exchange water. The contents were sufficiently mixed to prepare an aqueous dispersion.

The dispersion was heated in a hot-water bath with stirring until the temperature reached 75° C. Then, mixed monomers containing 70.26 parts by mass of methyl methacrylate (MMA), 16.83 parts by mass of butylacrylate (BA), 2.15 parts by mass of acrylic acid (AA), and 0.893 parts by mass of γ-methacryloxypropyl triethoxysilane, and 14 parts by mass of ammonium persulfate (APS) (1% by mass aqueous solution) were added dropwise continuously to the flask over three hours, so that polymerization was conducted (the added amount of each monomer is the amount based on 199.68 parts by mass of the aqueous dispersion before addition of ion-exchange water). After dropwise addition of the mixed monomers, the mixture was aged at 80° C. for two hours. After the aging, the reaction liquid was cooled to ambient temperatures and the reaction was terminated. To the liquid, 7.14 parts by mass of a 50% by mass solution of EMULGEN 120 (Kao Corporation) was added. The mixture was neutralized with triethylamine to the pH value of 7.5, thereby preparing an aqueous dispersion (solid content concentration 51% by mass) of polymer particles. The resulting polymer particles had a fluorine content of 30% by mass, a particle size of 210 nm, a glass transition temperature of 40° C., and a minimum film-forming temperature of 45° C. The resulting aqueous dispersion is regarded as an aqueous dispersion 1.

### Synthesis Example 2

A 0.5-L four-necked glass separable flask equipped with a stirrer, a reflux tube, a thermometer, and an addition funnel was charged with 199.68 parts by mass of an aqueous dispersion (solid content concentration of 45.5% by mass) of VdF/TFE/CTFE copolymers (VdF/TFE/CTFE=72.1/14.9/13 (mol %)) as an aqueous dispersion containing fluoropolymer seed particles, 12.75 parts by mass of Newcol 707SF (Nippon Nyukazai Co., Ltd.), and 35 parts by mass of ion-exchange water. The contents were sufficiently mixed to prepare an aqueous dispersion.

The dispersion was heated in a water bath with stirring until the temperature reached 75° C. Then, mixed monomers containing 61.89 parts by mass of methyl methacrylate (MMA), 25.2 parts by mass of butylacrylate (BA), 2.15 parts by mass of acrylic acid (AA), and 0.893 parts by mass of γ-methacryloxypropyl triethoxysilane, and 14 parts by mass of ammonium persulfate (APS) (1% by mass aqueous solution) were added dropwise continuously to the flask over three hours, so that polymerization was conducted (the added amount of each monomer is the amount based on 199.68 parts by mass of the aqueous dispersion before addition of ion-exchange water). After dropwise addition of the mixed monomers, the mixture was aged at 80° C. for two hours. After the aging, the reaction liquid was cooled to ambient temperatures and the reaction was terminated. To the liquid, 7.14 parts by mass of a 50% by mass solution of EMULGEN 120 (Kao Corporation) was added. The mixture was neutralized with triethylamine to the pH value of 7.5, thereby preparing an aqueous dispersion (solid content concentration 51% by mass) of polymer particles. The resulting polymer particles had a fluorine content of 30% by mass, a particle size of 200 nm, a glass transition temperature of 30° C., and a minimum film-forming temperature of 35° C.

The resulting aqueous dispersion is regarded as an aqueous dispersion 2.

### Synthesis Example 3

A 2-L four-necked glass separable flask equipped with a stirrer, a reflux tube, a thermometer, and an addition funnel was charged with 591.62 parts by mass of an aqueous dispersion (solid content concentration of 45.5% by mass) of VdF/TFE/CTFE copolymers (VdF/TFE/CTFE=72.1/14.9/13 (mol %)) as an aqueous dispersion containing fluoropolymer seed particles, 37.88 parts by mass of Newcol 707SF (Nippon Nyukazai Co., Ltd.), and 100 parts by mass of ion-exchange water. The contents were sufficiently mixed to prepare an aqueous dispersion.

The dispersion was heated in a water bath with stirring until the temperature reached 75° C. Then, mixed monomers containing 174.10 parts by mass of methyl methacrylate (MMA), 73.31 parts by mass of butylacrylate (BA), 12.27 parts by mass of 2-hydroxy ethyl methacrylate (2HEMA), 6.50 parts by mass of acrylic acid (AA), and 2.60 parts by mass of γ-methacryloxypropyl triethoxysilane, and 14 parts by mass of ammonium persulfate (APS) (1% by mass aqueous solution) were added dropwise continuously to the flask over three hours (the added amount of each monomer is the amount based on 591.62 parts by mass of the aqueous dispersion before addition of ion-exchange water). After the dropwise addition of the mixed monomers, the mixture was aged at 80° C. for two hours. After the aging, the reaction liquid was cooled to ambient temperatures and the reaction was terminated. To the liquid, 21.25 parts by mass of a 50% by mass solution of EMULGEN 120 (Kao Corporation) was added. The mixture was neutralized with triethylamine to the pH value of 7.5, thereby preparing an aqueous dispersion (solid content concentration 51% by mass) of polymer particles. The resulting polymer particles had a fluorine content of 30% by mass, a particle size of 200 nm, and a glass transition temperature of 35° C.

The resulting aqueous dispersion is regarded as an aqueous dispersion 3.

### Synthesis Example 4

A 0.5-L four-necked glass separable flask equipped with a stirrer, a reflux tube, a thermometer, and an addition funnel was charged with 280 parts by mass of an aqueous dispersion (solid content concentration of 45.8% by mass) of VdF/TFE/CTFE copolymers (VdF/TFE/CTFE=72.1/14.9/13 (mol %)) as an aqueous dispersion containing fluoropolymer seed particles, 26.75 parts by mass of Newcol 707SF (Nippon Nyukazai Co., Ltd.), and 35 parts by mass of ion-exchange water. The contents were sufficiently mixed to prepare an aqueous dispersion.

The dispersion was heated in a water bath with stirring until the temperature reached 75° C. Then, mixed monomers containing 100.16 parts by mass of methyl methacrylate (MMA), 23.97 parts by mass of butylacrylate (BA), and 3.08 parts by mass of acrylic acid (AA), and 20.3 parts by mass of ammonium persulfate (APS) (1% by mass aqueous solution) were added dropwise continuously to the flask over three hours, so that polymerization was conducted (the added amount of each monomer is the amount based on 280 parts by mass of the aqueous dispersion before addition of ion-exchange water). After the dropwise addition of the mixed monomers, the mixture was aged at 80° C. for two hours. After the aging, the reaction liquid was cooled to ambient temperatures and the reaction was terminated. To the liquid, 7.14 parts by mass of a 50% by mass solution of EMULGEN 120 (Kao Corporation) was added. The mixture was neutralized with triethylamine to the pH value of 7.5, thereby preparing an aqueous dispersion (solid content concentration 51% by mass) of polymer particles. The resulting polymer particles had a fluorine content of 30% by mass, a particle size of 200 nm, and a minimum film-forming temperature of 45° C.

The resulting aqueous dispersion is regarded as an aqueous dispersion 4.

### Comparative Examples 1 to 4

To the aqueous dispersions 1 to 4 (each in an amount of 100 parts by mass), 3.57 parts by mass of diethylene glycol diethyl ether (DEDG) was added with stirring, thereby preparing clear coating compositions 1 to 4.

### Examples 1 to 7

To each of the clear coating compositions 1 to 3 (each in an amount of 100 parts by mass), a crosslinking agent having carbodiimide groups (CARBODILITE E-02 (trade name)) or a crosslinking agent having oxazoline groups (EPOCROS WS-500) was added. The composition was mixed to prepare a composition containing polymer particles and the crosslinking agent. The added amount of the crosslinking agent is shown in Table 1.

### Comparative Example 5

To the clear coating composition 4 (in an amount of 100 parts by mass), a crosslinking agent having oxazoline groups (EPOCROS WS-500) was added. The mixture was mixed to prepare a composition containing polymer particles and the crosslinking agent. The added amount of the crosslinking agent is shown in Table 1.

Table 1 shows the results of the tests performed using the resulting compositions.

TABLE 1

| | | Example 1 | Example 2 | Example 3 | Example 4 | Example 5 | Example 6 | Example 7 |
|---|---|---|---|---|---|---|---|---|
| Polymer | Clear coating composition 1 | ◯ | ◯ | ◯ | ◯ | | | |
| particles A | Clear coating composition 2 | | | | | ◯ | ◯ | |
| | Clear coating composition 3 | | | | | | | ◯ |
| | Clear coating composition 4 | | | | | | | |
| Crosslinking | EPOCROS WS-500 | 0.3 | | | | 0.3 | | 0.3 |
| agent B* | CARBODILITE E-02 | | 0.5 | 1 | 2 | | 0.5 | |

| | | | | | | | |
|---|---|---|---|---|---|---|---|
| Resistance to hot water | ++ | ++ | ++ | ++ | ++ | ++ | ++ |
| Freeze-thaw resistance | ++ | ++ | ++ | ++ | ++ | ++ | ++ |
| Blocking resistance | ++ | ++ | ++ | ++ | + | + | + |
| Transparency | ++ | ++ | ++ | ++ | ++ | ++ | ++ |

| | | Comparative | Comparative | Comparative | Comparative | Comparative |
|---|---|---|---|---|---|---|
| | | Example 1 | Example 2 | Example 3 | Example 4 | Example 5 |
| Polymer | Clear coating composition 1 | ◯ | | | | |
| particles A | Clear coating composition 2 | | ◯ | | | |
| | Clear coating composition 3 | | | ◯ | | |
| | Clear coating composition 4 | | | | ◯ | ◯ |
| Crosslinking | EPOCROS WS-500 | | | | | 0.3 |
| agent B* | CARBODILITE E-02 | | | | | |

| | | | | | |
|---|---|---|---|---|---|
| Resistance to hot water | + | ++ | − | − | − |
| Freeze-thaw resistance | − | − | − | − | ++ |
| Blocking resistance | + | + | − | − | − |
| Transparency | ++ | ++ | − | − | − |

*The amount of the crosslinking agent mentioned is the amount in terms of functional groups of polymer particles

### INDUSTRIAL APPLICABILITY

The composition of the present invention is excellent in transparency and resistance to hot water, and therefore can form a film excellent in adhesion to a base material and blocking resistance. Accordingly, the composition of the present invention is suitably used as a coating composition especially for siding materials.

1. A composition comprising polymer particles (A) and a crosslinking agent (B),
the polymer particles (A) obtainable by seed polymerization of at least one monomer selected from the group consisting of acrylic acid esters and methacrylic acid esters, an unsaturated carboxylic acid, and a hydrolyzable silyl group-containing monomer in the presence of fluoropolymer particles as seed particles, and
the crosslinking agent (B) having at least one group selected from the group consisting of aziridine, carbodiimide, and oxazoline groups.

2. The composition according to claim 1,
wherein the polymer particles (A) contain
a polymerization unit derived from the acrylic acid esters and methacrylic acid esters in an amount of 40 to 400% by mass relative to the amount of the seed particles, and
a polymerization unit derived from the hydrolyzable silyl group-containing monomer in an amount of 0.1 to 2% by mass relative to the amount of the polymerization unit derived from the acrylic acid esters and methacrylic acid esters.

3. The composition according to claim 1,
wherein the seed particles are fluoropolymer particles derived from at least one fluoroolefin selected from the group consisting of vinyl fluoride, vinylidene fluoride, tetrafluoroethylene, hexafluoropropylene, and chlorotrifluoroethylene.

4. The composition according to claim 1,
wherein the hydrolyzable silyl group-containing monomer is at least one selected from the group consisting of γ-methacryloxypropyl trimethoxysilane, γ-methacryloxypropylmethyl dimethoxysilane, γ-methacryloxypropyl triethoxysilane, and γ-methacryloxypropylmethyl diethoxysilane.

5. A coated article comprising a base material, and a film obtainable by application of the composition according to claim 1 to the base material.

6. The coated article according to claim 5, which is a siding material.
